(19) United States
(12) Patent Application Publication
(10) Pub. No.: US 2002/0001504 A1
(43) Pub. Date: Jan. 3, 2002

(54) Threaded compression-enhanced fastening device for use with threaded rods

(76) Inventor: James P. McCallion, Laguna Hills, CA (US)

Correspondence Address: Joseph C. Andras, Myers Dawes & Andras LLP, Suite 1150, 19900 MacArthur Blvd., Irvine, CA, 92612, US

(21) Appl. No.: 09/758,537

(22) Filed: Jan. 10, 2001

Related U.S. Application Data
(60) Provisional application No. 60/175,370, filed on Jan. 10, 2000.

(51) Int. Cl. F16B 2/14; F16B 2/18; B25G 3/20; F16B 7/04

(52) U.S. Cl. 403/374.3

(57) ABSTRACT

Disclosed is a compression-based fastening device that is suitable for use with threaded fiberglass reinforced polymer (FRP) rod. FRP rod is often desirable due to certain favorable characteristics relative to metallic rods. Threaded FRP rod, however, has been somewhat unsatisfactory to date owing to the weakness of its thread structure. The herein disclosed device makes a threaded connection to a threaded FRP rod with an ultimate tensile strength that is several times greater than previously has been achieved with FRP rod, thereby effectively enabling FRP rod to be used in place of threaded steel rod. The preferred device includes a barrel with a tapered interior and a jaw assembly with a tapered exterior and internal threads. The jaw assembly's interior thread's engage the threaded FRP rod and the jaw assembly's tapered exterior slidably engages the barrel's tapered interior. As such, tightening the jaw assembly onto the threaded RFP rod also pulls the jaw assembly into the barrel's tapered interior so as to compress the jaw assembly against the threaded RFP rod and enhance the tensile strength of the threaded connection. Numerous embodiments are possible in terms of the configuration of the barrel, the jaw assembly, and the structure (e.g. an integral or separable nut) used to apply a tightening torque to the jaw assembly.

This patent application claims the priority date benefit of U.S. provisional patent application No. 60/175,370, filed on Jan. 10, 2000.

### FIELD OF THE INVENTION

The present invention relates generally to threaded mechanical fastening and, more particularly, to a threaded compression-enhanced rod fastening device suitable for use with threaded rods including those made of fiberglass reinforced polymer (FRP) materials.

### BACKGROUND OF THE RELATED ART

FRP materials exhibit superior strength and corrosion resistant properties when compared to metallic materials such as carbon steel. FRP materials are used in environments where these qualities are not only important, but necessary. Typically FRP materials are formed from a matrix of a resin, and fiber reinforcement. Typically the resin forms the corrosion portion of the matrix, and the fiber reinforcement the strength of the matrix. There are many types of resin, and similarly many types of fiber reinforcement, and any number of combinations thereof.

The common configuration of materials used for fastening systems are externally threaded cylindrical rods, which allow another component of a fastening system, an internally threaded nut, to engage the externally threaded rod.

Threaded FRP materials have only been used on a limited basis since FRP cannot be readily threaded with the threading options that are employed with metallic materials. Threading FRP cylindrical rod in the fashion used for metallic materials cuts through the fiber reinforcement of the FRP matrix, resulting in a discontinuity of strength at the thread.

Various alternative methods have been employed to impart a thread to cylindrical FRP rods. These include, but are not limited to, pressing a thread pattern onto a smooth rod during the production of the rod, or applying and bonding a hollow externally threaded tube over the rod.

Even then, however, there is still a problem with load transference between the nut and the threaded FRP rod. Since the surface of most FRP materials is not as hard as metallic materials, the nut/rod thread mesh must be exact to accomplish enhanced load transference. To date this exact nut/rod thread mesh is almost impossible to accomplish on a wide scaled, production basis.

The currently used means of enhancing the nut/rod thread mesh include, among others, using more than one nut, applying an adhesive to the threaded prior to compliment engagement, or both.

There remains a need, therefore, for a threaded rod fastening device suitable for use with threaded FRP rods that does not suffer from the foregoing disadvantages.

It is therefore an object of the present invention to provide a viable method of using the potential strength of threaded FRP materials to their fullest.

It is another object of the present invention to provide a viable method of using the potential strength of threaded FRP materials to their fullest without the necessity to use any additional bonding agents and;

It is a further object of the present invention to provide a superior method of attaching devices, one to another, using threaded FRP materials as the means of attachment.

Other objects of the present invention will become clear as this description proceeds.

### SUMMARY OF THE INVENTION

In a first aspect, the invention resides in a threaded compression-enhanced fastening device adapted for use with a threaded rod, comprising: a barrel having a tapered bore that is adapted for being placed over the threaded rod; a jaw section having a tapered exterior that engages the barrel's tapered bore and a threaded interior adapted for engaging the threaded rod; and means for transmitting a torque to and rotating the jaw section, the barrel and the jaw section being sized such that when the barrel is placed over the threaded rod, the jaw section may be easily threaded onto the rod and into the barrel's tapered bore, the jaw section further including a slit that permits the jaw section to close normal to a longitudinal centerline of the fastening device, the jaw section compressing around the threaded rod and increasing a mesh between the threaded rod's external threads and the jaw section's internal threads by virtue of an increasing confinement produced by entry of the jaw section into the tapered pore of the barrel as the jaw section is turned onto the threaded rod.

In a second aspect, the invention resides in a threaded compression-enhanced connection, comprising: a threaded rod; a barrel having a tapered bore through which the threaded rod extends; a jaw section having a tapered exterior that engages the barrel's tapered bore and a threaded interior that engages the threaded rod; and means for transmitting a torque to and rotating the jaw section, the barrel and the jaw section sized such that when the barrel is placed over the threaded rod, the jaw section may be easily threaded onto the rod while entering the barrel's tapered bore, the jaw section further including a slit that permits the jaw section to close normal to a longitudinal centerline of the fastening device, the jaw section compressing around the threaded rod and increasing a mesh between the threaded rod's external threads and the jaw section's internal threads by virtue of an increasing confinement produced by entry of the jaw section into the tapered pore of the barrel as the jaw section is turned onto the threaded rod.

### BRIEF DESCRIPTION OF THE DRAWINGS

The just summarized invention can be best understood with reference to the following description taken in view of the drawings of which:

FIG. 1 is an exploded perspective view of a first preferred embodiment of a threaded rod fastening device according to this invention;

FIG. 2 is a cutaway sectional view of the fastening device of FIG. 1 with the components assembled together and installed on a threaded FRP rod;

FIG. 3 is an elevational view of the downstream side of the fastening device of FIG. 2 taken along section lines A-A′;

FIG. 4 is an elevational view of the upstream side of the fastening device of FIG. 2 taken along section lines B-B′;

FIG. 5 is a cross-section of the jaw “B” of FIG. 3 taken along section lines C-C′;

FIG. 6 is a sectional view of a second preferred fastening device having an alternative jaw assembly and an independent cap that engages the jaw assembly;

FIG. 7 is an elevational view of the cap “E” of FIG. 6 when viewed from the downstream portion of the device along section lines D-D′;

FIG. 8 is an elevational view of the jaw assembly B of FIG. 6 when viewed from the upstream portion of the device along section lines E-E′; and

FIG. 9 shows another embodiment where the barrel and the jaw section have complementary threads (cross-hatched) on their tapered walls.

### DETAILED DESCRIPTION OF THE PREFERRED EMBODIMENTS

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein specifically to provide a viable method of using the potential strength of threaded FRP materials to their fullest without using any additional fastening devices, or bonding agents. The threads may be of any of the options noted in Mark's Standard Handbook for Mechanical Engineers, 7^{th} Edition, ISBN#16-12915, Chapters 3, 8, & 13, as pertains to thread devices, hereby incorporated by reference as if set forth herein, or any other type of thread design.

### FIRST PREFERRED EMBODIMENT

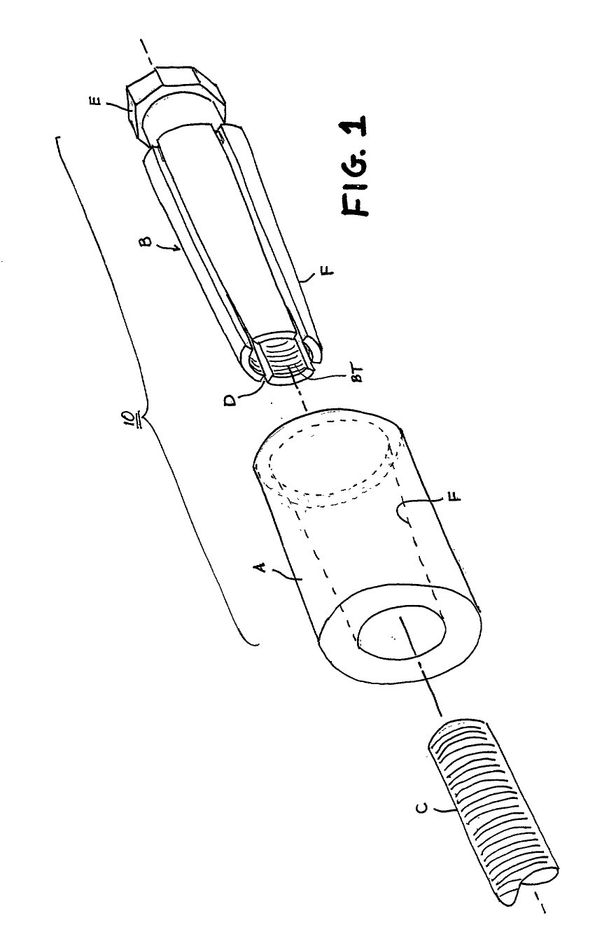

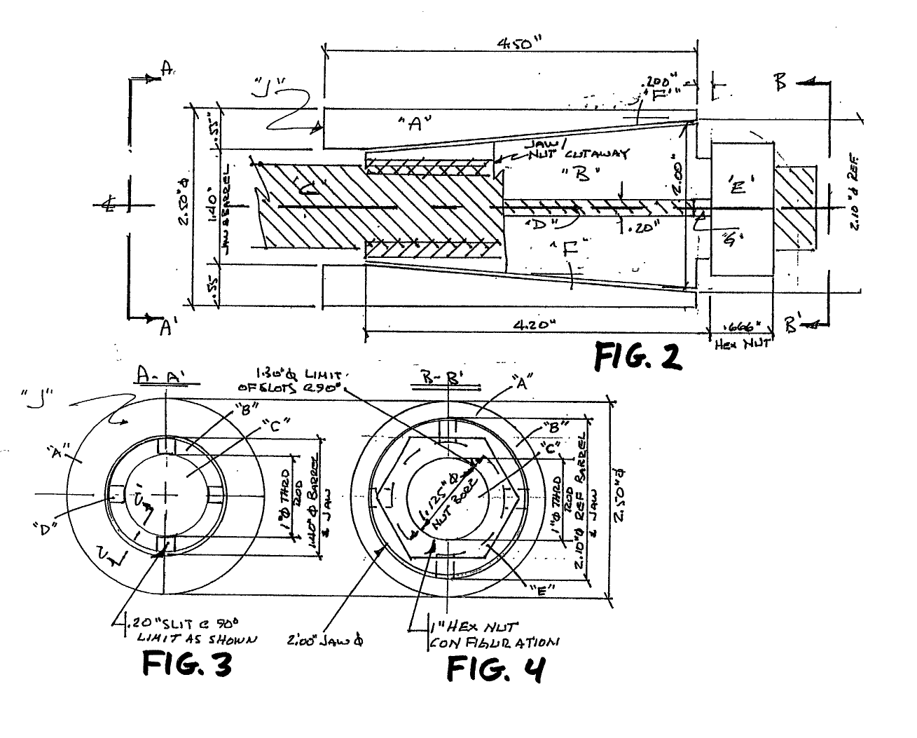

FIGS. 1 and 2 are an exploded perspective view and a cutaway sectional view, respectively, of a first preferred embodiment 10 of the present invention that engages a threaded rod “C”, i.e. a threaded FRP rod. In this embodiment, the rod's externally threaded portion and the device's internally threaded portion are shown to have complimentary diameters of 1″. It can be readily understood, however, that other diameters may be used. In fact, the thread diameter and other dimensional data that is noted here and in the drawings is only provided in order to give some perspective to the presentation. The specified dimensions should not be regarded as providing any sort of limitation on the design or function of the device, or as a limitation on the scope of the below-stated claims.

As suggested by FIG. 1, the device 10 is passed over and threaded onto the rod “C”. Not shown, but evident from FIG. 2, is the component to which the device is being fastened. This component would bear against the surface noted as “J”.

As collectively shown in FIGS. 1 and 2, the first preferred device comprises a cylindrical barrel “A” and a jaw section “B” that cooperatively engage the threaded rod “C”. This and other embodiments of the invention beneficially provide a threaded connection that is quickly made and that exhibits superior tensile strength relative to conventional approaches such as double nuts or the applications of adhesive to the threads. In tests conducted by the inventor, a threaded FRP rod that was secured with a single nut exhibited an ultimate tensile strength of about 6,500 lbs., a threaded FRP rod that was secured with two nuts exhibited an ultimate tensile strength of about 9,500 lbs., and threaded FRP rod secured with the device of FIGS. 1 and 2 exhibited an ultimate tensile strength of about 55,650 lbs.

The barrel “A” and jaw section “B” are independent of each other while having complementary configurations. The barrel “A” has a smooth tapered bore. The jaw section “B” includes slots “D” that define individual jaws. The jaws section “B” further has internal jaw threads “BT” that threadably engage the threaded rod “C” and a smooth external surface that slidingly engages the smooth tapered bore of the barrel In this first embodiment, the jaw section “B” includes an integral nut “E”. The device 10 may be installed through the following procedure and removed by reversing the procedure. The barrel “A” and jaw section “B” are so formed that when the barrel “A” is placed over the rod “C”, the integral nut “E” of the jaw section “B” may be easily threaded unto the rod “C” with the internal threads “BT” of the jaw section “B” turning loosely about the threaded rod “C” as the jaw section “B” turns into the barrel “A”. The integral nut “E” of the jaw section and its internal threads “BT” are firmly tightened, or meshed to the rod by further rotating the integral nut, “E”.

In more detail, by rotating the hexagonal portion of the integral nut “E”, the overall jaw section “B” is forced into the barrel “A”, and the internally threaded jaws “B” further engage the externally threaded rod “C”. Significantly, the barrel “A” and the jaw section “B” have complimentary tapers, “F” & “F”. A slot “D” (four in this case) permits the jaws to move normal to the longitudinal axis of the rod “C” and, thereby, close tightly around the externally threaded rod “C” with more contact area and better load transfer capability. A shoulder “G” (see FIG. 2) is at a diameter less than the external, but greater than the internal diameter of the jaw section “B”.

The construction of the first preferred embodiment may be further understood with reference to FIGS. 3, 4 and 5.

FIG. 3 is an elevational view of the downstream side of the assembled device of FIG. 2 taken along section lines A-A′. FIG. 3 shows the relationship of the barrel, “A”, the individual jaws of the jaw section “B”, and the slots “D” located between the individual jaws. In this particular embodiment, there are four slots “D” located at equal at 90 degree increments in the jaw section “B”.

FIG. 4 is an elevational view of the upstream side of the assembled device of FIG. 2 viewed along section lines B-B′. This figure shows the relationship of the barrel “A”, the jaw section “B”, and the hexagonal configuration of the integral nut “E” that, as already noted, is physically contiguous with the jaw section “B” in this particular embodiment.

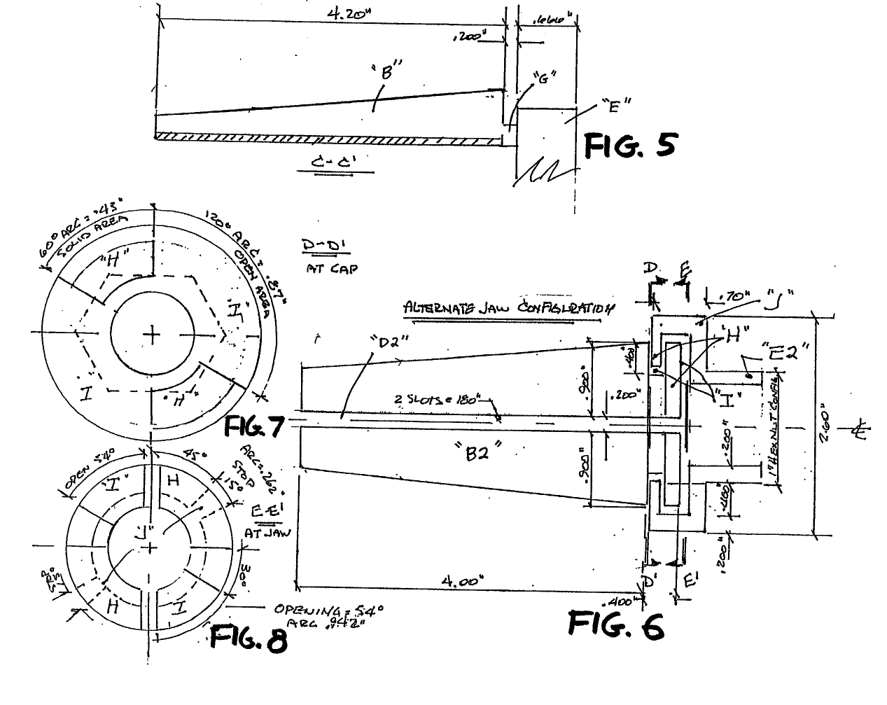

FIG. 5, finally, is a cross-section of a portion of the jaw section “B” as viewed along section lines C-C′ of FIG. 3.

### Second Preferred Embodiment

FIGS. 6, 7 and 8 relate to a device 10 made according to a second preferred embodiment. As best shown in FIG. 6, the second preferred device 10 has an alternative jaw configuration where the rotating portion of the device “E2” is independent of the jaw section “B2”. In more detail, the device 10 uses a jaw section “B2” having only two slots “D2” (equally positioned at 180 degrees) , and the rotating portion of the device 10 comprises a separable nut section “E2” or cap. It should be noted that while this embodiment shows a hexagonal “nut” configuration, any configuration that permits application of sufficient torque may be used.

FIGS. 7 and 8, taken together with FIG. 6, show how the separable nut section “E2” selectively engages the jaw section “B2” through a cooperative “bayonet” -like arrangements of lips and slots.

FIG. 7 shows the nut section “E2” as viewed from the downstream side that engages the jaw section “B2”. Clearly visible are a pair of inwardly extending arcuate flanges “H” and a pair of open areas or arcuate slots “I” that provide access to the gap (not numbered) beneath the flanges “H”.

FIG. 8, conversely, shows the jaw section “B2” as viewed from the upstream side that engages the nut section “E2”. Visible here, likewise, are a pair of inwardly extending flanges “H” and a pair of slots “I” that provide access to the gap (not numbered) beneath the flanges “H”. As shown, the jaws section “B2” also include a pair of stops “J” that are angularly positioned at 45 degrees relative to the slots “D2”. The purpose of the stops “J” will become evident.

As should now be apparent, the flanges and slots are complimentary to one another. When proper aligned and axially converged, the jaw section's flanges “H” travel axially into the nut's slots “I” and the nut's flanges “H” travel axially in the opposite direction into the jaw section's slots “I”.

A typical application of the second preferred device 10, therefore, would comprise the steps of (1) assembling the device 10 by moving the separable nut section “E2” over the jaw section “B2” so that their respective flanges “H” entire their respective slots “I”; (2) positioning the entire device 10 over the threaded rod “C” and into the barrel “A” as hereinbefore described with respect to the first embodiment; (3) rotating the separable nut section “E2” until the nut's flanges “H” to rotate beneath the jaw section's flanges “H” and encounter the stops “J” ; and then (4) further rotating the separable nut section “E2” to thread the entire device 10 onto the threaded rod “C” and into the barrel “B” so as to firmly compress the jaw section “B2” against the threaded rod “C”. It is also possible to first install the barrel “A” and the jaw section “B2”, and then install the separable nut section “E2” onto the jaw section “B2”. The device 10, of course, may be removed by reversing either procedure.

### Third Preferred Embodiment

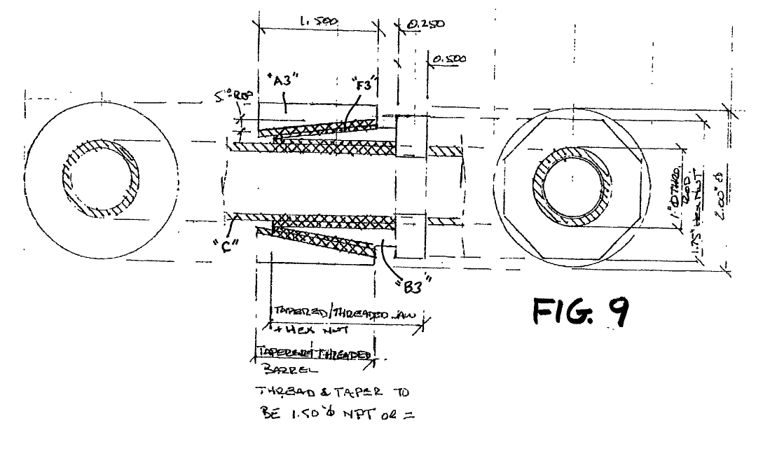

FIG. 9 shows another embodiment where an alternative barrel “A3” has threads (cross-hatched) on its tapered wall “F3” and where a complimentary jaw section “B3” has two sets of threads, an internal set of threads (cross-hatched) that engages the external threads of the threaded rod “C” and an external set of threads (crosshatched) that engages the internal threads of the barrel “A3”. The advantages of this embodiment are that the alternative barrel “A3” and complimentary jaw section “B3” may be previously assembled, loosely, via engagement of the respective threads, prior to fixing the combination onto a threaded rod “C”.

### Fourth Preferred Embodiment

In this embodiment, the barrel “B” (see FIGS. 1 and 2) and the separable nut section “C2” are fashioned as one piece. the assembly and overall function would be as immediately hereinbefore described for FIGS. 6, 7 and 8.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A threaded compression-enhanced fastening device adapted for use with a threaded rod, comprising:
a barrel having a tapered bore that is adapted for being placed over the threaded rod;
a jaw section having a tapered exterior that engages the barrel's tapered bore and a threaded interior adapted for engaging the threaded rod; and
means for transmitting a torque to and rotating the jaw section, the barrel and the jaw section being sized such that when the barrel is placed over the threaded rod, the jaw section may be easily threaded onto the rod and into the barrel's tapered bore, the jaw section further including a slit that permits the jaw section to close normal to a longitudinal centerline of the fastening device, the jaw section compressing around the threaded rod and increasing a mesh between the threaded rod's external threads and the jaw section's internal threads by virtue of an increasing confinement produced by entry of the jaw section into the tapered pore of the barrel as the jaw section is turned onto the threaded rod.

2. The threaded compression-enhanced fastening device of claim 1 wherein the means for transmitting a torque to and rotating the jaw section comprises:
a nut section adapted for turning onto the threaded rod; and
means for coupling the nut section to the jaw section such that nut section and the jaw section turn together.

3. The threaded compression-enhanced fastening device of claim 2 wherein the means for coupling the nut section to the jaw section comprises the jaw section and nut section being an integral structure.

4. The threaded compression-enhanced fastening device of claim 2 wherein the nut section is integral with the jaw section.

5. The threaded compression-enhanced fastening device of claim 2 wherein the nut section is separable from the jaw section.

6. The threaded compression-enhanced fastening device of claim 1 wherein the barrel's tapered bore is smooth and wherein the jaw sections exterior is smooth.

7. The threaded compression-enhanced fastening device of claim 1 wherein the barrel's tapered bore is threaded and wherein the jaw section's exterior is threaded.

8. The threaded compression-enhanced fastening device of claim 1 wherein the barrel and jaw section are constructed of metallic material.

9. The threaded compression-enhanced fastening device of claim 1 wherein the barrel and jaw section are constructed of a non-metallic material.

10. The threaded compression-enhanced fastening device of claim 1 wherein the threaded rod is metallic.

11. The threaded compression-enhanced fastening device of claim 1 wherein the threaded rod is made from a fiberglass reinforced plastic (FRP) material.

12. A threaded compression-enhanced connection, comprising:
a threaded rod;
a barrel having a tapered bore through which the threaded rod extends;
a jaw section having a tapered exterior that engages the barrel's tapered bore and a threaded interior that engages the threaded rod; and
means for transmitting a torque to and rotating the jaw section,
the barrel and the jaw section sized such that when the barrel is placed over the threaded rod, the jaw section may be easily threaded onto the rod while entering the barrel's tapered bore,
the jaw section further including a slit that permits the jaw section to close normal to a longitudinal centerline of the fastening device, the jaw section compressing around the threaded rod and increasing a mesh between the threaded rod's external threads and the jaw section's internal threads by virtue of an increasing confinement produced by entry of the jaw section into the tapered pore of the barrel as the jaw section is turned onto the threaded rod.

13. The threaded compression-enhanced connection of claim 12 wherein the threaded rod is metallic.

14. The threaded compression-enhanced connection of claim 12 wherein the threaded rod is made from a fiberglass reinforced plastic (FRP) material.
